(19) United States
(12) Patent Application Publication
(10) Pub. No.: US 2012/0043845 A1
(43) Pub. Date: Feb. 23, 2012

(54) Sensorless Three-Phased BLDC Motor and Stator thereof

(76) Inventors: Alex HORNG, Kaohsiung (TW); Ming-Sheng WANG, Kaohsiung (TW); Yung-Hui WU, Kaohsiung (TW); Li-Yang LYU, Kaohsiung (TW)

(21) Appl. No.: 12/859,951

(22) Filed: Aug. 20, 2010

(51) Int. Cl. H02K 3/00

(52) U.S. Cl. 310/195

(57) ABSTRACT

A sensorless three-phased brushless direct current (BLDC) motor comprises a stator, a rotor and a driving unit. The stator has a first-phased coil, a second-phased coil and a third-phased coil. Each of the first-phased, second-phased and third-phased coils has a varying inductance value. The varying inductance value has an inductance changing rate greater than 15%. The rotor has a plurality of magnetic poles, each having a magnetic pole face facing the stator. The driving unit has a power input end and a signal input/output end. The signal input/output end is coupled to the first-phased, second-phased and third-phased coils, and the power input end is used to receive power for maintaining operation of the driving unit.

### BACKGROUND OF THE INVENTION

1. Field of the Invention

The present invention generally relates to a brushless direct current (BLDC) motor and, more particularly, to a three-phased BLDC motor which can rapidly detect a start location of a rotor without any sensor.

2. Description of the Related Art

BLDC motors have been widely used in electronic products due to its high efficiency. In a conventional BLDC motor, the location of a magnetic pole where a rotor is positioned at is often detected by a Hall sensor of the BLDC motor. In some occasions, however, it is not suitable to use the Hall sensor due to environment restriction. For example, the performance of the Hall sensor may be affected by extremely heat air generated by a compressor. As a result, start of the BLDC motors could be badly interfered.

In light of the problem, sensorless techniques have been developed to overcome the drawback encountered during the start of the BLDC motor. Generally, a sensorless starting method of a conventional BLDC motor includes a rotor-positioning step and an open-looped start step. During the rotor-positioning step, a stator coil is excited by a constant current in order to position a rotor at a start location. Next, the open-looped start step is performed to rotate the rotor in a predetermined direction. Based on the steps, sensorless start of the BLDC motor is completed.

However, the conventional sensorless starting method above has some drawbacks. For example, when a direction of a magnetic field generated by two adjacent magnetic poles of a stator is the same as a direction of a magnetic field generated by two magnetic poles of a rotor facing the two adjacent magnetic poles, magnetic forces generated on both sides will repel each other and the magnetic forces will have zero resultant force. This is typically a case where the rotor is positioned at a dead location. In this case, the rotor is likely to shake or even rotates in an opposite direction if the subsequent open-looped start step is forcibly executed. Therefore, it is desired to improve the conventional sensorless starting method.

### SUMMARY OF THE INVENTION

It is therefore the objective of this invention to provide a sensorless three-phased BLDC motor which accurately detects a location of a rotor thereof during a start procedure, thereby preventing shaking of the rotor and shortening the time required for the start procedure.

The invention discloses a sensorless three-phased BLDC motor comprising a stator, a rotor and a driving unit. The stator has a first-phased coil, a second-phased coil and a third-phased coil. Each of the first-phased, second-phased and third-phased coils has a varying inductance value. The varying inductance value has an inductance changing rate greater than 15%. The rotor has a plurality of magnetic poles, each having a magnetic pole face facing the stator. The driving unit has a power input end and a signal input/output end. The signal input/output end is coupled to the first-phased, second-phased and third-phased coils, and the power input end is used to receive power for maintaining operation of the driving unit.

Furthermore, the invention discloses a stator of a sensorless three-phased BLDC motor comprising a first-phased coil, a second-phased coil and a third-phased coil. Each of the first-phased, second-phased and third-phased coils has an inductance value. The inductance value has a maximal inductance value, a minimal inductance value and an inductance value variation. The inductance value variation is a difference between the maximal inductance value and the minimal inductance value and has an inductance changing rate greater than 15% with respect to the maximal inductance value.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a system diagram of a sensorless three-phased BLDC motor according to a preferred embodiment of the invention.

FIG. 2 shows a structure diagram of a stator of the sensorless three-phased BLDC motor according to the preferred embodiment of the invention.

FIG. 3 shows inductance values of coils of the sensorless three-phased BLDC motor with respect to rotor angle.

FIG. 4 shows inductance values of coils of the sensorless three-phased BLDC motor with respect to rotor angle according to the preferred embodiment of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

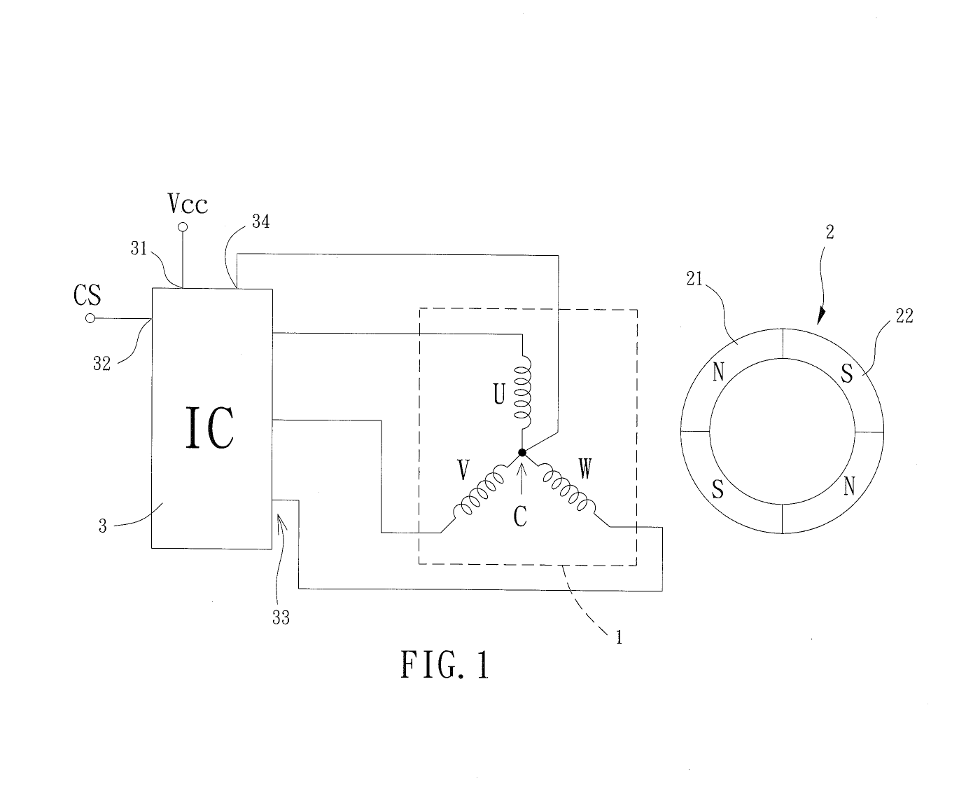

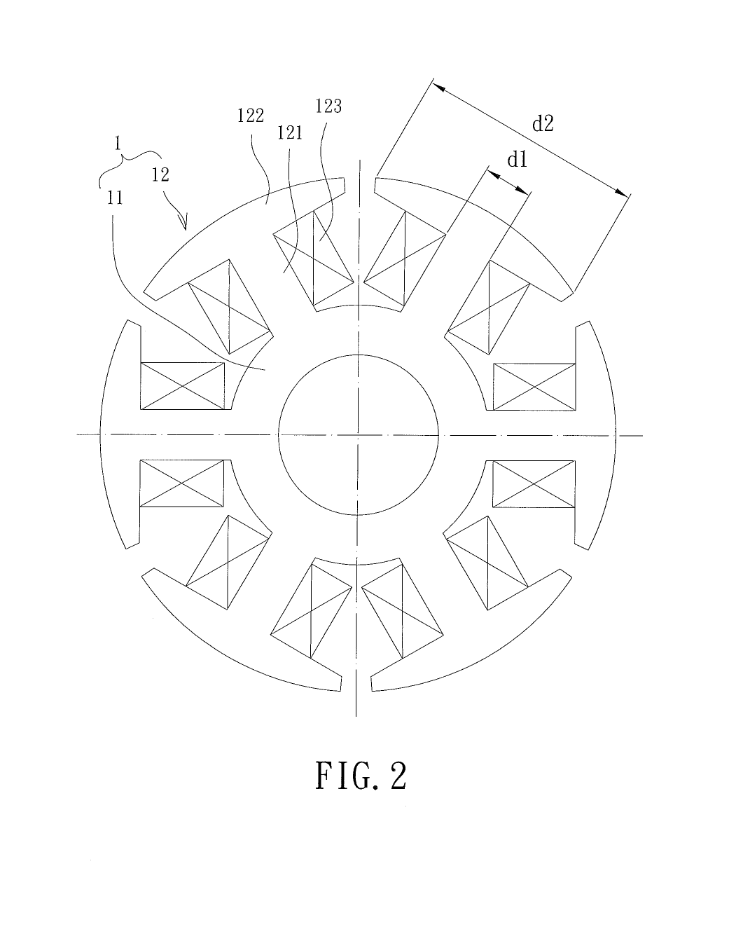

Referring to FIG. 1, a system diagram of a sensorless three-phased BLDC motor is shown according to a preferred embodiment of the invention. In this embodiment, the sensorless three-phased BLDC motor is implemented as an outer-rotor-type sensorless three-phased BLDC motor for illustration. However, an inner-rotor-type sensorless three-phased BLDC motor may also be used. The sensorless three-phased BLDC motor includes a stator 1, a rotor 2 and a driving unit 3. The stator 1 includes a first-phased coil U, a second-phased coil V and a third-phased coil W. The coils U, V and W may be connected into a Y-shape structure having a neutral node C, or connected into a triangle structure. Referring to FIG. 2, a structure diagram of the stator 1 is shown. The stator 1 includes a base 11 and a plurality of magnetic pole members 12 connected to a periphery of the base 11 and extending outwards in a radial direction of the stator 1. Each magnetic pole member 12 includes an arm 121, an excitation portion 122 and a coil 123. The arm 121 is connected between the base 11 and the excitation portion 122 and extends in the radial direction of the stator 1. The arm 121 has a width d1 and the excitation portion 122 has a width d2 in a peripheral direction of the stator 1. The coil 123 is wound around the arm 121 to form the coil U, V or W.

Referring to FIG. 1 again, the rotor 2 includes at least one N pole 21 and at least one S pole 22. Each of the at least one N pole 21 and at least one S pole 22 has a magnetic pole face facing the stator 1. The driving unit 3 may be a driving circuit preferably including a driving chip or a Micro Control Unit (MCU). The driving unit 3 includes a power input end 31, a command end 32 and a signal input/output end (signal I/O end) 33. The power input end 31 receives power for maintaining operation of the driving unit 3. The command end 32 receives a control signal CS. The signal I/O end 33 is electrically connected to the coils U, V and W of the stator 1. Based on this, currents passing through the coils U, V and W may be sent to the driving unit 3 via the signal I/O end 33. Also, driving power generated by the driving unit 3 may be sent to the coils U, V and W via the signal I/O end 33. In the case where the coils U, V and W are connected as the Y-shape structure having the neutral node C, the driving unit 3 further includes a neutral connection end 34 connected to the neutral node C of the stator 1. In addition, a predetermined rotational speed of the rotor 2 may be determined merely by a voltage level received by the power input end 31, thus omitting the command end 32.

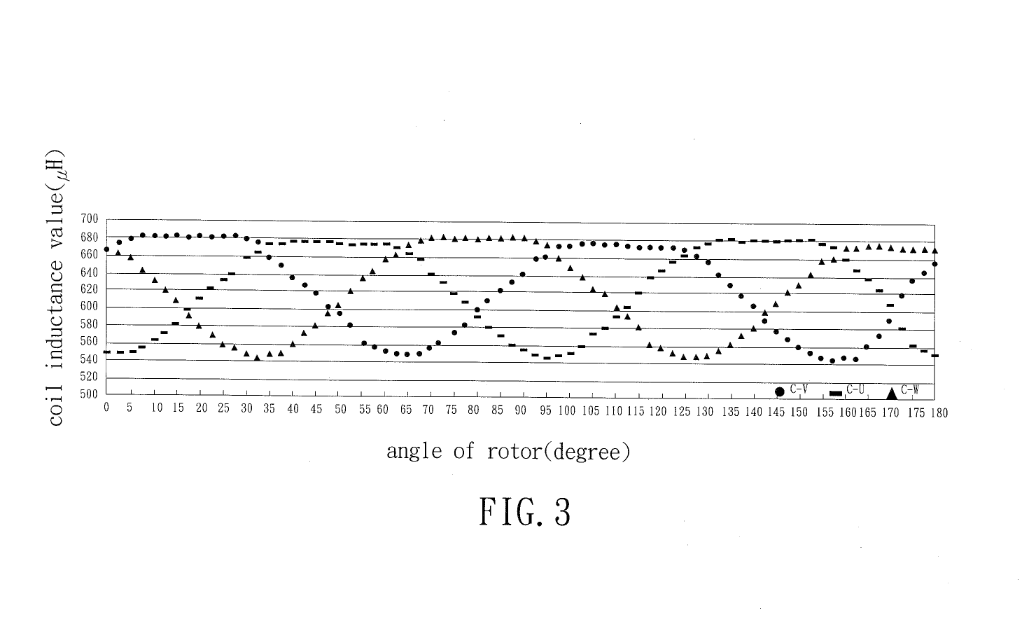

Specifically, when the rotor 2 is about to start, the driving unit 3 may send a test signal to any two coils of the stator 1 (such as the second-phased coil V and third-phased coil W) via the signal I/O end 33 and detect an induced electromotive force on another coil not receiving the test signal (such as the first-phased coil U). Thus, a varying inductance value of that coil not receiving the test signal may be obtained. Varying inductance values on all the coils U, V and W may be obtained in the same way. Note the detected varying inductance value on each of the coils U, V and W does not remain in a constant value due to the magnetic forces generated by the at least one N pole 21 and the at least one S pole 22, but appears to have a periodic pattern based on different location of the rotor 2. As shown in FIG. 3, the varying inductance values of the coils U, V and W are shown to have periodic patterns in a condition where magnetic fields are generated by two N poles 21 and two S poles 22. In FIG. 3, the vertical axis represents inductance values of the coils U, V and W, and the horizontal axis represents an angle value of the rotor 2 from 0 to 180 degree. In addition, the relative relation of the inductance values of the coils U, V and W with respect to the angle value of the rotor 2 from 180 to 360 degree is similar to that of inductance values of the coils U, V and W with respect to the angle value of the rotor 2 from 0 to 180 degree. In this way, the driving unit 3 is able to detect relative locations of the rotor 2 and the stator 1, and further sends out the driving power via the signal I/O end 33 that is suitable for starting the rotor 2 positioned at that detected location.

The characteristic of the sensorless three-phased BLDC motor of the invention is described below. Based on the periodically varying inductance values of the coils U, V and W, each varying inductance value has a maximal inductance value Lₘₐₓ, a minimal inductance value Lₘᵢₙ and an inductance value variation, with the inductance value variation being the difference between the maximal inductance value Lₘₐₓ and the minimal inductance value Lₘᵢₙ. The inductance value variation has an inductance changing rate R greater than 15% with respect to the maximal inductance value Lₘₐₓ, which is preferably between 20% and 60%. In other words, the inductance changing rate R is expressed as a formula below:

$$R = \frac{{L}_{max} - {L}_{min}}{{L}_{max}} > 15 \% \qquad ( 1 )$$

Since the inductance changing rate R of each of the coils U, V and W is greater than 15%, the driving unit 3 is able to detect the specific location of the rotor 2 under the magnetic field generated by the stator 1 prior to sending out the driving power. Thus, erroneous determination of the location of the rotor 2 caused by the inductance changing rate R being too small may be avoided. Hence, the sensorless three-phased BLDC motor of the invention may efficiently avoid the shaking or even reversed rotation of the rotor 2 during start procedure thereof, and also shorten the transient time required for achieving a corresponding rotational speed of the control signal CS from a stationary state.

Referring to FIG. 2 again, there are many factors that could affect the inductance changing rate R of the coils U, V and W. The main ones are categorized below.

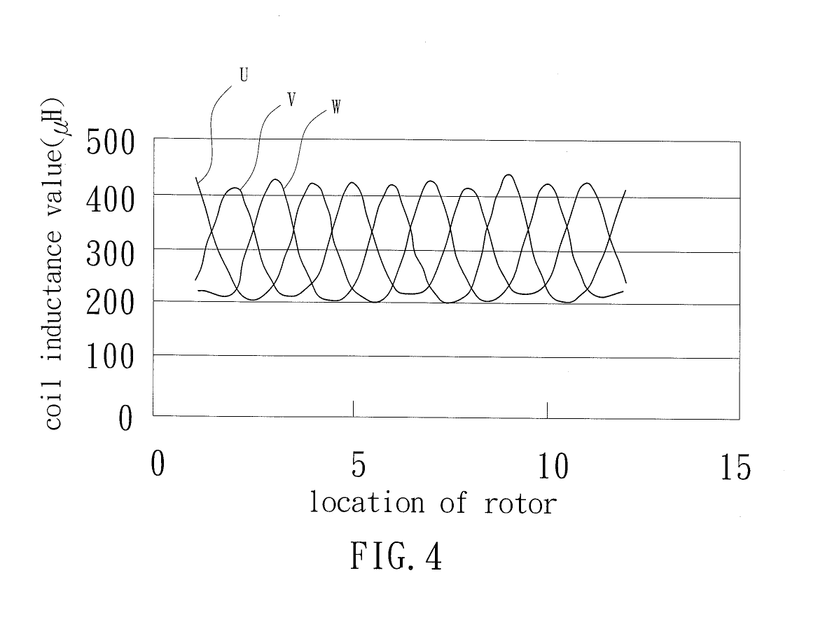

The first one is magnetic energy product of the materials of the at least one N pole 21 and at least one S pole 22. The second one is the width d1 of the arm 121. The third one is the number of turns of the coil 123. The magnetic energy product above is preferably greater than 3 MGOe, with being greater than 5 MGOe more preferred. A ratio of the width d1 of the arm 121 to the width d2 of the excitation portion 122 is preferably smaller than 35%, with being smaller than 23% more preferred. The number of turns of the coil 123 is preferably greater than 80, with being greater than 100 more preferred. Referring to FIG. 4, the variation curves of the inductance values of the coils U, V and W are shown under conditions where the magnetic energy product is 5 MGOe, the ratio of the width d1 of the arm 121 to the width d2 of the excitation portion 122 is 22% and number of turns of the coil 123 is 110. In FIG. 4, the vertical axis represents the inductance value of the coils U, V and W, and the horizontal axis represents location of the rotor 2. Specifically, the maximal inductance value Lₘₐₓ and the minimal inductance value Lₘᵢₙ, of the first-phased coil U are respectively 427.6 uH and 200 uH, which may be used in the formula (I) to determine an inductance changing rate R1 thereof:

$${R}_{1} = \frac{{L}_{max} - {L}_{min}}{{L}_{max}} = \frac{427.6 - 200}{427.6} = 53.2 \% \qquad ( 2 )$$

Therefore, the inductance changing rate R1 of the first-phased coil U is 53.2%.

In addition, the maximal inductance value Lₘₐₓ and the minimal inductance value Lₘᵢₙ, of the second-phased coil V are respectively 427 uH and 210.7 uH, which may be used in the formula (I) to determine an inductance changing rate R2 thereof:

$${R}_{2} = \frac{{L}_{max} - {L}_{min}}{{L}_{max}} = \frac{427 - 210.7}{427} = 50.7 \% \qquad ( 3 )$$

Therefore, the inductance changing rate R2 of the second-phased coil V is 50.7%.

In addition, the maximal inductance value Lₘₐₓ and the minimal inductance value Lₘᵢₙ of the third-phased coil W are respectively 439.3 uH and 198 uH, which may be used in the formula (I) to determine an inductance changing rate R3 thereof:

$${R}_{3} = \frac{{L}_{max} - {L}_{min}}{{L}_{max}} = \frac{439.3 - 198}{439.3} = 54.9 \% \qquad ( 4 )$$

Therefore, the inductance changing rate R3 of the third-phased coil W is 54.9%.

Furthermore, in a case where the test signal is sent to the coils U, V and W when the inductance changing rates R1, R2 and R3 are greater than 15%, the test signal is chosen to have an amplitude higher than 3 to 4.5 mV for detecting the varying inductance values of the coils U, V and W. The amplitude of 3 to 4.5 mV of the test signal may allow the rotor 2 to rotate in a speed of 20 to 30 RPM as the rotor 2 is initially started. After the rotor 2 rotates in a stable speed of 1000 RPM, the driving power has an amplitude higher than 150 mV.

Based on the above description, by having the inductance changing rates R1, R2 and R3 of the coils U, V and W greater than 15%, the location of the rotor 2 may be accurately detected before starting the sensorless three-phased BLDC motor. In addition, the relative locations of the rotor 2 and the stator 1 may be determined based on the detected location of the rotor 2, allowing the driving unit 3 to send out the driving power suitable for starting the rotor 2 positioned at that location detected. Therefore, the sensorless three-phased BLDC motor of the invention may efficiently avoid the shaking or even reversed rotation of the rotor 2 during start procedure thereof, and further shorten the transient time required for achieving a corresponding rotational speed from a stationary state.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A sensorless three-phased brushless direct current (BLDC) motor, comprising:
a stator having a first-phased coil, a second-phased coil and a third-phased coil, each of the first-phased, second-phased and third-phased coils has a varying inductance value, the varying inductance value has an inductance changing rate greater than 15%;
a rotor having a plurality of magnetic poles, each having a magnetic pole face facing the stator; and
a driving unit having a power input end and a signal input/output end, wherein the signal input/output end is coupled to the first-phased, second-phased and third-phased coils, and the power input end is used to receive power for maintaining operation of the driving unit.

2. The sensorless three-phased BLDC motor as claimed in claim 1, wherein the inductance changing rate is between 20% and 60%.

3. The sensorless three-phased BLDC motor as claimed in claim 1, wherein the rotor is made of materials having a magnetic energy product greater than 3 MGOe.

4. The sensorless three-phased BLDC motor as claimed in claim 1, wherein the stator includes a base and a plurality of magnetic pole members connected to the base and extending outwards in a radial direction of the stator, each of the magnetic pole members includes an excitation portion and an aim connected between the base and the excitation portion, the arm has a width and the excitation portion has a width in a peripheral direction of the stator, a ratio of the width of the arm to the width of the excitation portion is smaller than 35%.

5. The sensorless three-phased BLDC motor as claimed in claim 1, wherein the stator includes a base and a plurality of magnetic pole members connected to the base, each of the magnetic pole members includes a coil and an arm extending in a radial direction of the stator, the coil is wound around the arm to form the first-phased, second-phased or third-phased coil, and the number of turns of the coil is greater than 80.

6. A stator of a sensorless three-phased brushless direct current (BLDC) motor, comprising a first-phased coil, a second-phased coil and a third-phased coil, wherein each of the first-phased, second-phased and third-phased coils has a varying inductance value, the varying inductance value has a maximal inductance value, a minimal inductance value and an inductance value variation, the inductance value variation is a difference between the maximal inductance value and the minimal inductance value and has an inductance changing rate greater than 15% with respect to the maximal inductance value.

7. The stator of the sensorless three-phased BLDC motor as claimed in claim 6, wherein the inductance changing rate is between 20% and 60%.

8. The stator of the sensorless three-phased BLDC motor as claimed in claim 6, further comprising a base and a plurality of magnetic pole members connected to the base and extending outwards in a radial direction of the stator, each of the magnetic pole members includes an excitation portion and an arm connected between the base and the excitation portion, the arm has a width and the excitation portion has a width in a peripheral direction of the stator, a ratio of the width of the arm to the width of the excitation portion is smaller than 35%.

9. The stator of the sensorless three-phased BLDC motor as claimed in claim 6, further comprising a base and a plurality of magnetic pole members connected to the base, each of the magnetic pole members includes a coil and an arm extending in a radial direction of the stator, the coil is wound around the arm to form the first-phased, second-phased or third-phased coil, and the number of turns of the coil is greater than 80.
